(19) United States
(12) Patent Application Publication
(10) Pub. No.: US 2020/0224067 A1
(43) Pub. Date: Jul. 16, 2020

(54) Pressure-Sensitive Adhesive Based on EPDM

(71) Applicant: TESA SE, Norderstedt (DE)

(72) Inventors: Tobias VON WEDEL-PARLOW, Hamburg (DE); Maike STREBL, Hamburg (DE)

(21) Appl. No.: 15/757,891

(22) PCT Filed: Sep. 7, 2016
(86) PCT No.: PCT/EP2016/071094

§ 371 Date: Mar. 6, 2018

(30) Foreign Application Priority Data
Sep. 11, 2015 (DE) 10 2015 217 376.3

(51) Int. Cl. C09J 123/16; C09J 7/38; B32B 27/08

(52) U.S. Cl. CPC C09J 123/16; C09J 7/38; B32B 2405/00; C09J 2201/606; B32B 27/08

(57) ABSTRACT

The invention relates to a pressure-sensitive adhesive composition containing, as a base polymer, at least one or more solid EPDM-rubbers and adhesive resins, the proportion of adhesive resins being between 30-130 phr. The adhesive composition free of plasticizers.

The invention relates to the composition of an adhesive based on EPDM rubber, and also to the use thereof.

Pressure-sensitive adhesives (PSAs) have been known for some considerable time. PSAs are adhesives which allow durable bonding to the substrate even under relatively weak applied pressure and which after use can be detached again substantially without residue from the substrate. At room temperature, PSAs exhibit a permanently adhesive effect, thus having a sufficiently low viscosity and a high tack, and so wetting the surface of the respective bond substrate even with little applied pressure. The bondability of the adhesives and the redetachability are based on their adhesive properties and on their cohesive properties. A variety of compounds are suitable as a basis for PSAs.

Adhesive tapes equipped with PSAs, referred to as pressure-sensitive adhesive tapes, are nowadays put to diverse uses in the industrial and household spheres. Pressure-sensitive adhesive tapes consist customarily of a carrier film which is furnished on one or both sides with a PSA. There are also pressure-sensitive adhesive tapes which consist exclusively of a layer of PSA and no carrier film, these being referred to as transfer tapes. The composition of the pressure-sensitive adhesive tapes may differ greatly and is guided by the particular requirements of the various applications. The carriers consist customarily of polymeric films such as, for example, polypropylene, polyethylene or polyester, or else of paper, fabric or nonwoven.

The self-adhesive or pressure-sensitive adhesive compositions consist customarily of acrylate copolymers, silicones, natural rubber, synthetic rubber, styrene block copolymers or polyurethanes.

In order to adjust application-relevant properties, PSAs can be modified by the admixing of tackifier resins, plasticizer, crosslinkers or fillers.

Fillers are used, for example, to boost the cohesion of a PSA. In this case a combination of filler/filler interactions and filler/polymer interactions frequently leads to the desired reinforcement of the polymer matrix.

Fillers are also admixed, for the purpose of increasing weight and/or increasing volume, in paper, to plastics and also to adhesives and coating materials, and to other products. The addition of filler often improves the technical usability of the products and has an influence on their quality—for example, strength, hardness, etc. The natural, inorganic and organic fillers such as calcium carbonate, kaolin, talc, dolomite and the like are produced mechanically.

In the case of rubber and synthetic elastomers as well, suitable fillers can be used to improve the quality—for example, hardness, strength, elasticity, and elongation. Fillers much in use are carbonates, especially calcium carbonate, or else silicates (talc, clay, mica), siliceous earth, calcium sulfate and barium sulfate, aluminum hydroxide, glass fibers, glass beads, and carbon blacks.

Organic and inorganic fillers can also be distinguished according to their density. Hence the inorganic fillers often used in plastics and also adhesives, such as chalk, titanium dioxide, calcium sulfate and barium sulfate, increase the density of the composite, since they themselves have a density which is higher than that of the polymer. For a given film thickness, the weight per unit area is then higher.

There are also fillers which are able to reduce the overall density of the composite. These include hollow microspheres, very voluminous lightweight fillers. The spheres are filled with air, nitrogen or carbon dioxide; the shells of these spheres consist of glass or else, with certain products, of a thermoplastic.

Particularly in the case of applications in the automotive segment, plastics are being used with increasing frequency in place of metals. These plastics generally possess a low surface energy, which makes bonding to these substrates more difficult. Moreover, adhesive bonds are to be as stable as possible with respect to aging and heat. To date, the products used have been primarily based on acrylates (aging-stable, but not good on LSE surfaces (LSE: low surface energy), SBC synthetic rubbers (good on LSE, but not heat-resistant), or natural rubber (good on LSE, but not aging-stable). There is still, however, a lack of solutions which combine all the good properties.

The LSE surfaces include, in particular, PVA, polystyrene, PE, PP, EVA or Teflon.

EPDM adhesives are known in the prior art.

They are frequently EPDM/thermoplastic blends and are therefore hotmelt adhesives. Also known are EPDM-based PSAs which require a further polymer in order to bring about the adhesive tack, and which therefore represent blends. Generally speaking, sufficient shear strength is achieved only through subsequent crosslinking (usually sulfur vulcanization or peroxide crosslinking).

It is an object of the invention to portray a possibility by which pressure-sensitive adhesives based on EPDM are available for technical applications, said adhesives exhibiting the profile of properties of customary PSAs, with as far as possible a reduction in costs and with no loss of peel adhesion even after prolonged storage in various media, and ensuring high bond strength particularly on low-energy surfaces.

This object is achieved by means of a pressure-sensitive adhesive as specified in the main claim. The dependent claims relate to advantageous developments of the subject matter of the invention. The invention further encompasses the use of this PSA.

The invention accordingly provides a pressure-sensitive adhesive which comprises as base polymer at least one or more solid EPDM rubbers and also tackifier resins, the fraction of the tackifier resins being 30 to 130 phr, and in accordance with the invention the adhesive being plasticizer-free.

The figures given below in phr denote parts by weight of the relevant component per 100 parts by weight of all EPDM polymer components of the PSA, in other words, for example, without taking account of the tackifier resins. The EPDM polymer components here encompass all solid EPDM rubbers and also any liquid EPDM rubbers present (at room temperature).

The wt % datum is always based on the composition of the overall PSA.

Moreover, the possibility of crosslinking them using high-energy beams, UV light or chemicals such as peroxides, phenolic resins or sulfur compounds is an advantage.

The EPDM rubber, furthermore, may be functionalized with further functional groups such as, for example, silanes, acrylates or maleic anhydride, by means of reactive grafting, for example. These functionalities likewise permit subsequent crosslinking.

In addition, crosslinkers and crosslinking promoters may be admixed. Suitable crosslinkers for electron beam crosslinking and peroxide crosslinking are, for example, di- or polyfunctional acrylates, maleimides, quinones, cyanurates, di- or polyfunctional isocyanates (including those in blocked form), or di- or polyfunctional epoxides.

EPDM rubbers are ethylene-propylene rubbers with a diene. EPDM rubbers of the invention comprise besides ethylene and propylene, as a diene, according to one preferred variant, ethylidene-norbornene (ENB), dicyclopentadiene or 5-vinyl-2-norbornene.

The Mooney viscosity (ML 1+4/125° C.) of the EPDM rubbers, measured according to DIN 53523, is preferably at least 20 to 120, more preferably 40 to 90, and more particularly 50 to 80.

The EPDM rubbers may have been admixed with inert release assistants such as talc, silicates (talc, clay, mica), zinc stearate, and PVC powders, more particularly in an order of magnitude of 3 phr.

The release assistants are preferably selected from the group consisting of talc, silicates (talc, clay, mica), zinc stearate, and PVC powder.

Furthermore, preferably, the EPDM rubber may be admixed with thermoplastic elastomers such as synthetic rubbers, for example, with a fraction of up to 5 wt %, for the purpose of improving the processing qualities.

Particular representatives in this context include the particularly compatible styrene-isoprene-styrene (SIS) and styrene-butadiene-styrene (SBS) grades.

Besides one or more solid EPDM rubbers, PSAs of the invention may preferably comprise at least one liquid EPDM rubber, with the liquid EPDM rubber(s) being likewise plasticizer-free.

The fraction of the liquid EPDM rubbers is preferably up to 40 wt %, more preferably between 5 and 35 wt %, more preferably between 10 and 25 wt %. (Here again, the wt % datum is based on the composition of the overall PSA, thus including the tackifier resins.)

Liquid rubbers are distinguished from solid rubbers in that they have a softening point. The latter is <80° C., preferably <60° C., and very preferably <40° C.

The figures for the softening point Tₛ of oligomeric and polymeric compounds, such as of the resins, for example, are based on the ring and ball method as per DIN EN 1427:2007, with corresponding application of the provisions (investigation of the oligomer or polymer sample instead of bitumen, with the procedure otherwise retained); the measurements take place in a glycerol bath.

The base polymer preferably consists of solid, or solid and liquid, EPDM rubbers, and more preferably there is no other polymer in the PSA besides the EPDM rubbers.

In this case the PSA is a composition of solid and liquid EPDM rubbers, one or more tackifier resins, preferably aging inhibitor(s), and optionally release assistants, which represents one preferred embodiment. Additionally, furthermore, the fillers and/or dyes elucidated later on may optionally be included in small amounts.

Alternatively the base polymer contains more than 90 wt %, preferably more than 95 wt %, of solid and liquid EPDM rubber.

The term “tackifier resin” is understood by the skilled person to refer to a resin-based substance which increases the tack.

As tackifier resins it is possible, in the case of the self-adhesive composition, for example, to use hydrogenated and unhydrogenated hydrocarbon resins and polyterpene resins, in particular, as the main component. Suitable with preference, among others, are hydrogenated polymers of dicyclopentadiene (for example, Escorez 5300 series; Exxon Chemicals), hydrogenated polymers of preferably C₈ and C₉ aromatics (for example, Regalite and Regalrez series; Eastman Inc., or Arkon P series; Arakawa). These may originate through hydrogenation of polymers from pure aromatic streams or else may be based through hydrogenation of polymers based on mixtures of different aromatics. Also suitable are partially hydrogenated polymers of C₈ and C₉ aromatics (for example, Regalite and Regalrez series; Eastman Inc., or Arkon M; Arakawa), hydrogenated polyterpene resins (for example, Clearon M; Yasuhara), hydrogenated C₅/C₉ polymers (for example, ECR-373; Exxon Chemicals), aromatic-modified, selectively hydrogenated dicyclopentadiene derivatives (for example Escorez 5600 series, Exxon Chemicals). The aforesaid tackifier resins may be used either alone or in a mixture.

Hydrogenated hydrocarbon resins are particularly suitable as a blend component, as described for example in EP 0 447 855 A1, U.S. Pat. Nos. 4,133,731 A, and 4,820,746 A, since there can be no disruption to crosslinking in view of the absence of double bonds, and also the aging stability achieved is high.

Furthermore, however, unhydrogenated resins can also be employed, if crosslinking promoters such as polyfunctional acrylates, for example, are used.

Other unhydrogenated hydrocarbon resins, unhydrogenated analogs of the hydrogenated resins described above, can also be used.

Moreover, rosin-based resins (for example, Foral, Foralyn) can be used.

The aforementioned rosins include, for example, natural rosin, polymerized rosin, partially hydrogenated rosin, fully hydrogenated rosin, esterified products of these kinds of rosin (such as glycerol esters, pentaerythritol esters, ethylene glycol esters, and methyl esters), and rosin derivatives (such as disproportionation rosin, fumaric acid-modified rosin, and lime-modified rosin).

To stabilize the PSA it is common to add primary antioxidants such as, for example, sterically hindered phenols, secondary antioxidants such as, for example, phosphites or thioethers and/or C-radical scavengers.

The tackifier resins optionally comprise polyterpene resins based on α-pinene and/or β-pinene and/or δ-limone, or terpene-phenolic resins.

Any desired combinations of these may be used in order to adjust the properties of the resulting PSA in line with requirements. Reference may be made expressly to the representation of the state of knowledge in the “Handbook of Pressure Sensitive Adhesive Technology” by Donatas Satas (van Nostrand, 1989).

Resins used with particular preference are (partially) hydrogenated hydrocarbon resins, of the kind sold, for example, by Eastman under the trade names Eastotac and Regalite.

The amount by weight of the resins is 30 to 130 phr, preferably 50 to 120 phr, more preferably 60 to 110 phr.

Preferably, the pressure-sensitive adhesive consists of a composition only of solid, or only of solid and liquid, EPDM rubbers and tackifier resin, with the possible, additional, optimal addition of aging inhibitors.

For the EPDM-based PSA it is possible, for the purpose of adjusting optical and technical adhesive properties, for additives to be included such as fillers, dyes or aging inhibitors (antiozonants, antioxidants (primary and secondary), light stabilizers, etc.).

Additives to the adhesive that are typically utilized are as follows:
primary antioxidants such as, for example, sterically hindered phenols
secondary antioxidants such as, for example, phosphites or thioethers
light stabilizers such as, for example, UV absorbers or sterically hindered amines

The fillers may be reinforcing or nonreinforcing. Particularly noteworthy here are silicon dioxides (spherical, acicular or irregular such as pyrogenic silicas), phyllosilicates, calcium carbonates, zinc oxides, titanium dioxides, aluminum oxides or aluminum oxide hydroxides.

The concentration of the additives influencing the optical and technical adhesive properties is preferably up to 20 wt %, more preferably up to 15 wt %, more preferably up to 5 wt %.

In accordance with the invention the fractions of all substances added (besides EPDM rubber and tackifier resin), such as synthetic rubbers and/or thermoplastic elastomers and/or fillers and/or dyes and/or aging inhibitors, ought not to exceed a total of 5 wt %, preferably 2 wt %.

The substances recited are not mandatory; the adhesive also functions without the addition thereof individually or in any desired combination, in other words without synthetic rubbers and/or elastomers and/or fillers and/or dyes and/or aging inhibitors.

According to one preferred embodiment, the PSA of the invention is foamed. Foaming is accomplished by the introduction and subsequent expansion of microballoons.

“Microballoons” are elastic hollow microspheres, which accordingly can be expanded in their basic state, and which have a thermoplastic polymer shell. These spheres are filled with low-boiling liquids or with liquefied gas. Shell material used includes, in particular, polyacrylonitrile, PVDC, PVC or polyacrylates. Suitable low-boiling liquids are, in particular, hydrocarbons of the lower alkanes, such as isobutane or isopentane, for example, which are included in the form of liquefied gas under pressure in the polymer shell.

Action on the microballoons, and more particularly the action of heat, causes the outer polymer shell to soften. At the same time, the liquid blowing gas present within the shell undergoes transition into its gaseous state. This is accompanied by irreversible stretching of the microballoons, which expand three-dimensionally. Expansion is over when the internal pressure matches the external pressure. Since the polymeric shell is retained, a closed-cell foam is obtained accordingly.

There are a large number of types of microballoon available commercially, which differ essentially in their size (6 to 45 μm in diameter in the unexpanded state) and the onset temperatures they require for expansion (75 to 220° C.). One example of commercially available microballoons are the Expancel® DU products (DU=dry unexpanded) from Akzo Nobel.

Unexpanded types of microballoon are also available as an aqueous dispersion having a solids or microballoon fraction of around 40 to 45 wt %, and additionally in the form of polymer-bound microballoons (masterbatches), as for example in ethyl vinyl acetate with a microballoon concentration of around 65 wt %. The microballoon dispersions and the masterbatches as well, like the DU products, are suitable for producing a foamed PSA of the invention.

A foamed PSA of the invention may also be produced with what are called preexpanded microballoons. In the case of this group, the expansion takes place prior to incorporation into the polymer matrix. Preexpanded microballoons are available commercially, for example, under the designation Dualite® or with the product name Expancel xxx DE (Dry Expanded) from Akzo Nobel.

With preference in accordance with the invention, at least 90% of all the cavities formed by microballoons have a maximum diameter of 10 to 200 μm, more preferably of 15 to 200 μm. The “maximum diameter” means the maximum extent of a microballoon in any three-dimensional direction.

The diameter is determined using a cryofracture edge under a scanning electron microscope (SEM) at 500 times magnification. The diameter of each individual microballoon is determined graphically.

Where foaming takes place using microballoons, the microballoons may be supplied in the form of a batch, paste or an unextended or extended powder to the formulation. They may additionally be present in suspension in solvent.

According to one preferred embodiment of the invention, the fraction of the microballoons in the adhesive is between greater than 0 wt % and 10 wt %, more particularly between 0.25 wt % and 5 wt %, very especially between 0.5 and 2.5 wt %, based in each case on the overall composition of the adhesive.

The figure is based on unexpanded microballoons.

A polymer composition of the invention that comprises expandable hollow microspheres may additionally also include unexpandable hollow microspheres. The only critical issue is that almost all of the gas-containing enclosures are closed by a permanently impervious membrane, regardless of whether this membrane consists of an elastic and thermoplastically stretchable polymer mixture or, for instance, of elastic glass which is nonthermoplastic in the spectrum of temperatures possible in plastics processing.

Additionally suitable for the PSA of the invention—selected independently of other additives—are solid polymer beads, hollow glass beads, solid glass beads, hollow ceramic beads, solid ceramic beads and/or solid carbon beads (“carbon microballoons”).

The absolute density of a foamed PSA of the invention is preferably 350 to 990 kg/m³, more preferably 450 to 970 kg/m³, more particularly 500 to 900 kg/m³.

The relative density describes the ratio of the density of the foamed PSA of the invention to the density of the unfoamed PSA of the invention of identical formula. The relative density of a PSA of the invention is preferably 0.35 to 0.99, more preferably 0.45 to 0.97, more particularly 0.50 to 0.90.

Plasticizers are understood to be the low molecular mass plasticizing substances that are known from adhesive tape technology. Plasticizers in accordance with the invention are all substances with the exception of (liquid) EPDM rubbers which have a softening point of less than 60° C., preferably less than 40° C.

The plasticizers include in particular, among others, the paraffinic and naphthenic oils, (functionalized) oligomers such as oligobutadienes and oligoisoprenes, liquid nitrile rubbers, liquid terpene resins, vegetable and animal oils and fats, phthalates, and functionalized acrylates.

The adhesive of the invention does not have these plasticizers.

By “plasticizer-free” in the inventive sense is meant preferably that the PSA does entirely without plasticizer. Where impurities of plasticizers are present in the adhesive in a fraction of not more than 1 wt %, this is by definition included within the term “plasticizer-free”. In particular, the PSA does not contain—or contains at a fraction of not more than 1 wt %—paraffinic and naphthenic oils (functionalized) oligomers such as oligobutadienes and oligoisoprenes, liquid nitrile rubbers, liquid terpene resins, vegetable and animal oils and fats, phthalates and/or functionalized acrylates.

The PSA is utilized preferably for the furnishing of carriers, to give adhesive tapes.

Adhesive tapes in the sense of the invention are to comprehend all sheetlike or tapelike carrier formations coated on one or both sides with adhesive, hence including, in addition to conventional tapes, also decals, sections, diecuts (punched sheetlike carrier formations coated with adhesive), two-dimensionally extended structures (for example, sheets) and the like, and multilayer arrangements.

The expression “adhesive tape” also encompasses, furthermore, what are called “adhesive transfer tapes”, in other words adhesive tapes without carrier. In the case of an adhesive transfer tape, instead, the adhesive is applied between flexible liners prior to application, these liners being provided with a release layer and/or having antiadhesive properties. For application, generally speaking, first one liner is removed, the adhesive is applied, and then the second liner is removed.

Adhesive transfer tapes preferably have a thickness of 300 to 2000 μm.

The adhesive tape may be provided in fixed lengths, such as in the form of meter-length product, for example, or else as continuous product on rolls (Archimedean spiral).

The coat weight (coating thickness) of the adhesive is preferably between 10 and 200 g/m², more preferably between 15 and 100 g/m², very preferably between 20 and 70 g/m².

Carrier materials used for the pressure-sensitive adhesive tape are the carrier materials customary and familiar to the skilled person, such as paper, woven fabric, nonwoven, or films made, for example, of polyester such as polyethylene terephthalate (PET), polyethylene, polypropylene, oriented polypropylene, polyvinyl chloride. It is likewise possible to use carrier materials made from renewable raw materials such as paper, woven fabric made, for example, of cotton, hemp, jute, stinging-nettle fibers, or films composed, for example, of polylactic acid, cellulose, modified starch, polyhydroxyalkanoate. This recitation should not be understood as being conclusive; instead, within the bounds of the invention, the use of other films is also possible.

Particular preference is given to films made from PET and oriented polypropylene.

Further particularly preferred are foam carriers, especially acrylate foam carriers, which in turn may also be (pressure-sensitively) adhesive.

The carrier material may be furnished preferably on one or both sides with the PSA. In the case of the double-sided variant, only one of the two adhesives must be that of the invention.

In particular, the adhesive tape consisting of an acrylate foam carrier furnished on both sides with the PSA of the invention preferably has a thickness of 300 to 2000 μm.

The pressure-sensitive adhesive tape is formed by application of the adhesive, partially or over the whole area, to the carrier. Coating may also take place in the form of one or more strips in lengthwise direction (machine direction), optionally in transverse direction, but coating more particularly is over the full area. Furthermore, the adhesives may be applied in patterned dot format by means of screen printing, in which case the dots of adhesive may also differ in size and/or distribution, or by gravure printing of lines which join up in the lengthwise and transverse directions, by engraved-roller printing, or by flexographic printing. The adhesive may be in the form of domes (produced by screen printing) or else in another pattern such as lattices, stripes, zig-zag lines. Furthermore, for example, it may also have been applied by spraying, producing a more or less irregular pattern of application.

It is advantageous to use an adhesion promoter, referred to as a primer layer, between carrier and adhesive, or to use a physical pretreatment of the carrier surface for the purpose of improving the adhesion of the adhesive to the carrier.

Primers which can be used are the known dispersion systems and solvent systems, based for example on isoprene- or butadiene-containing rubber, acrylate rubber, polyvinyl, polyvinylidene and/or cyclo rubber. Isocyanates or epoxy resins as additives improve the adhesion and in some cases also increase the shear strength of the PSA. The adhesion promoter may likewise be applied by means of a coextrusion layer on one side of the carrier film. Examples of suitable physical surface treatments are flame treatment, corona or plasma, or coextrusion layers.

Furthermore, the carrier material, on the reverse face or upper face, in other words opposite the adhesive side, may have been subjected to an antiadhesive physical treatment or coating, and more particularly may have been furnished with a release agent or release (optionally blended with other polymers).

Examples are stearyl compounds (for example, polyvinylstearylcarbamate, stearyl compounds of transition metals such as Cr or Zr, ureas formed from polyethylenimine and stearyl isocyanate, or polysiloxanes. The term stearyl stands as a synonym for all linear or branched alkyls or alkenyls having a C number of at least 10 such as octadecyl, for example.

Suitable release agents further include surfactant-type release systems based on long-chain alkyl groups such as stearylsulfosuccinates or stearylsulfosuccinamates, but also polymers which may be selected from the group consisting of polyvinylstearylcarbamates such as, for example, Escoat 20 from Mayzo, polyethyleniminestearylcarbamides, chromium complexes of C₁₄ to C₂₈ fatty acids, and stearyl copolymers, as described in DE 28 45 541 A, for example. Likewise suitable are release agents based on acrylic polymers with perfluorinated alkyl groups, silicones based, for example, on poly(dimethylsiloxanes), or fluorosilicone compounds.

The carrier material may further be pretreated and/or aftertreated. Common pretreatments are hydrophobizing, corona pretreatments such as N₂ corona or plasma pretreatments; familiar aftertreatments are calendering, heating, laminating, punching, and enveloping.

The pressure-sensitive adhesive tape may likewise have been laminated with a commercial release film or release paper, which customarily comprises a base material of polyethylene, polypropylene, polyester or paper which has been coated with polysiloxane on one or both sides.

The pressure-sensitive adhesive film of the invention may be produced by customary coating methods known to the skilled person. In this context, the PSA, including the additives, in solution in a suitable solvent, may be coated onto a carrier film or release film by means, for example, of engraved-roller application, comma bar coating, multiroll coating, or in a printing process, after which the solvent can be removed in a drying tunnel or drying oven. Alternatively, the carrier film or release film may also be coated in a solvent-free process. For this purpose, the EPDM rubber is heated in an extruder and melted. Further operating steps may take place in the extruder, such as mixing with the above-described additives, filtration or degassing. The melt is then coated by means of a calender onto the carrier film or release film.

Possible methods by which EPDM rubber-based adhesives like that according to the invention are produced are found in DE 198 06 609 A1 and also in patents WO 94/11175 A1, WO 95/25774 A1, WO 97/07963 A1.

The pressure-sensitive adhesive tape of the invention preferably has a peel adhesion on a steel substrate of at least 6.0 N/cm for a coat weight of 50 g/m².

Further details, objectives, features, and advantages of the present invention will be elucidated in more detail below by reference to a number of figures which represent preferred working examples. In these figures

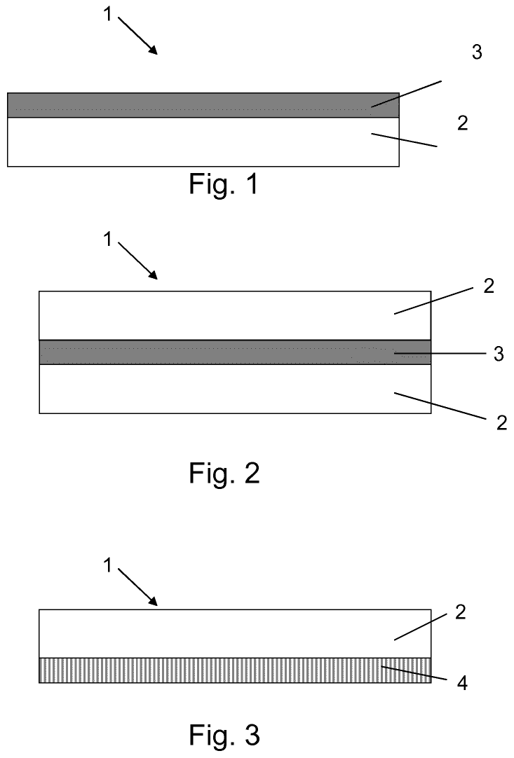

FIG. 1 shows a single-sided pressure-sensitive adhesive tape,

FIG. 2 shows a double-sided pressure-sensitive adhesive tape,

FIG. 3 shows a carrier-free pressure-sensitive adhesive tape (adhesive transfer tape).

FIG. 1 shows a single-sidedly adhering pressure-sensitive adhesive tape 1. The pressure-sensitive adhesive tape 1 has an adhesive layer 2 produced by coating one of the above-described PSAs onto a carrier 3. The PSA coat weight is preferably between 10 and 50 g/m².

Provided additionally (not shown) may be a release film, which covers and protects the adhesive layer 2 before the pressure-sensitive adhesive tape 1 is used. The release film is then removed before use from the adhesive layer 2.

The product construction shown in FIG. 2 shows a pressure-sensitive adhesive tape 1 with a carrier 3, coated on both sides with a PSA and therefore having two adhesive layers 2. The PSA coat weight per side is in turn preferably between 10 and 200 g/m².

With this embodiment as well, at least one adhesive layer 2 is preferably lined with a release film. In the case of a rolled-up adhesive tape, this one release film may optionally also line the second adhesive layer 2. However, it is also possible for a plurality of release films to be provided.

It is possible, furthermore, for the carrier film to be provided with one or more coatings. Moreover, only one side of the pressure-sensitive adhesive tape may be furnished with the inventive PSA, and a different PSA may be used on the other side.

The product construction shown in FIG. 3 shows a pressure-sensitive adhesive tape 1 in the form of an adhesive transfer tape, in other words a carrier-free pressure-sensitive adhesive tape 1. For this construction, the PSA is coated single-sidedly onto a release film 4, to form a pressure-sensitive adhesive layer 2. The PSA coat weight here is customarily between 10 and 100 g/m². This pressure-sensitive adhesive layer 2 is optionally also lined on its second side with a further release film. For the use of the pressure-sensitive adhesive tape, the release films are then removed.

As an alternative to release films it is also possible for example to use release papers or the like. In that case, however, the surface roughness of the release paper ought to be reduced, in order to realize a PSA side that is as smooth as possible.

In order to enhance the cohesive properties of the PSA, it may also be crosslinked with the methods described above and, in particular, through the addition of peroxides, the addition of a sulfur vulcanizing system, or with irradiation with high-energy radiation. This has positive effects on properties, in particular, such as the holding power or the micro-shear travel, whereas properties such as the peel adhesions tend to fall.

### Test Methods

Unless otherwise indicated, the measurements are carried out under test conditions of 23±1° C. and 50±5% relative humidity.

### Softening Point

The figures for the softening point Tₛ of oligomeric and polymeric compounds, such as of the resins, for example, are based on the ring & ball method according to DIN EN 1427:2007 with corresponding application of the provisions (investigation of the oligomer sample or polymer sample instead of bitumen, with the procedure otherwise retained); the measurements are made in a glycerol bath.

### Storage

Before the tests described below, the specimens are stored for at least 24 hours at 23° C. and 50% relative humidity.

### Peel Adhesion

The peel strength (peel adhesion) was tested in a method based on PSTC-1.

A strip of the pressure-sensitive adhesive tape, 2 cm wide, consisting of a PET film 23 μm thick and etched with trichloroacetic acid and of an adhesive coating applied thereto and 50 μm thick is adhered to the test substrate in the form of an ASTM steel plate by being rolled on back and forth five times using a 4 kg roller.

The surface of the steel plate is cleaned with acetone beforehand. The plate is clamped in, and the self-adhesive strip is peeled from its free end on a tensile testing machine at a peel angle of 180° and a speed of 300 mm/min (or with the other specified speeds), and a determination is made of the force needed to achieve this. The measurement results are reported in N/cm and are averaged over three measurements and reported with standardization to the width of the strip in N/cm.

The initial peel adhesion (peel adhesion to ASTM steel) was measured immediately after bonding and not more than 10 minutes after bonding. The peel adhesion on alternative substrates (e.g., polypropylene (PP)) was determined in accordance with the methodology above, by changing the bonding substrate.

### Micro-Shear Travel Measurement

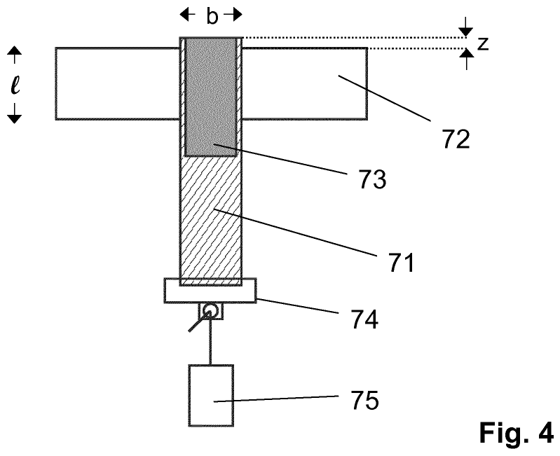

The measurement setup is illustrated in FIG. 4.

Flat pieces measuring 10 mm×50 mm were cut from the adhesive tape a, and the resulting adhesive tape specimen (71) was adhered to a polished, heatable steel test plate (72), which was 13 mm wide and had been cleaned with acetone, the bonding taking place such that the longitudinal direction of the adhesive tape specimen was oriented in the transverse direction of the steel plate, the bond area had dimensions of l×w=13 mm×10 mm, and the adhesive tape protruded beyond the steel plate on one side by a section of length z=2 mm. For fixing, a 2 kg steel roller was then rolled over the adhesive tape six times at a speed of 10 m/min. On the side of the adhesive tape (71) facing away from the steel plate (72), the adhesive tape (71) was reinforced, flush with the edge protruding by the section of length z beyond the steel plate, with a stable adhesive strip (73) (dimensions 4 mm×25 mm; PET film carrier 190 μm thick), which served as a support for a travel sensor (not shown). The arrangement thus prepared was suspended perpendicularly in such a way that the section of length z of the adhesive tape specimen (71) that protruded beyond the steel plate (72) pointed upward. The steel test plate (72) with the adhered sample (71) was heated to 40° C., and the adhesive tape specimen (71) for measurement was loaded at the lower end with a weight (75) of 100 g by means of a clamp (74) at the time t0=0. The travel sensor measured the deformation of the sample under shear over a period of 15 minutes (beginning at t0) at a temperature of 40° C. and a relative atmospheric humidity of 50±5%.

The result reported is the shearing distance in μm after 15 minutes (maximum value; distance travelled by top edge of the sample downward during the measurement). The shear travel thus measured is a quantitative measure of the crosslinking status of the sample submitted to measurement.

The intention of the text below is to illustrate the invention using a number of examples, without thereby wishing to subject the invention to unnecessary restriction.

### Preparation of the PSAs

The pressure-sensitive adhesives (PSAs) set out in the examples were homogenized as solvent-based compositions in a kneading apparatus with a double-sigma kneading hook. The solvent used was benzine (mixture of hydrocarbons). The kneading apparatus was cooled by means of water cooling.

First of all, in a first step, the solid EPDM rubber was pre-swollen with a third of the total amount of benzine and with the aging inhibitor and, optionally, fillers at 23° C. for 48 hours. This preliminary batch, as it is called, was then kneaded for 15 minutes. The resin was subsequently added in three equal-sized portions. After the first two additions, kneading took place for 10 minutes in each case, and for 40 minutes after the third addition. The liquid EPDM rubber or the plasticizers were then added, and kneading was continued for 10 minutes. After that, the second third of benzine was added and kneading took place for 20 minutes, before the last third of the total amount of benzine was incorporated with kneading for 30 minutes. The final solids content is 35 wt %.

### Production of the Test Specimens

The PSA was coated onto a PET film, 23 μm thick and etched with trichloroacetic acid, by means of a coating knife on a commercial laboratory coating bench (for example from the company SMO (Sondermaschinen Oschersleben GmbH)). The benzine was evaporated off in a forced air drying cabinet at 105° C. for 10 minutes. The slot width during coating was adjusted so as to achieve a coat weight of 50 g/m² following evaporation of the solvent. The films freed from the solvent were subsequently lined with siliconized PET film and stored pending further testing at 23° C. and 50% relative humidity.

| | | | Inv. | Inv. | Inv. | Inv. | Inv. | Inv. |
|---|---|---|---|---|---|---|---|---|
| Raw material | Type | Mooney viscosity | Ex. 1 | Ex. 2 | Ex. 3 | Ex. 4 | Ex. 5 | Ex. 6 |
| Vistalon 6602 | EPDM 49% | 25 (ML 1 + 4 125° C.) | | | | | 25.00 | |
| | ethylene | | | | | | | |
| Vistalon 2502 | EPDM 55% | 80 (ML 1 + 4 125° C.) | 30.00 | | | | | |
| | ethylene | | | | | | | |
| Keltan 69500 | EPDM 44% | 65 (ML 1 + 4 125° C.) | 20.00 | 35.00 | 30.00 | | | |
| | ethylene | | | | | | | |
| Vistalon 5601 | EPDM 69% | 72 (ML 1 + 4 125° C.) | 0.00 | | | | | |
| | ethylene | | | | | | | |
| Royalene 563 | EPDM 57% | 75 (ML 1 + 4 125° C.) | | | | 25.00 | | |
| | ethylene | | | | | | | |
| Royalene 547 | EPDM 57% | 80 (ML 1 + 4 125° C.) | | | | | | 25.00 |
| | ethylene | | | | | | | |
| Ondina 933 | Liquid paraffinic | | | | | | | |
| | white oil | | | | | | | |
| Trilene 67 | Liquid EPDM | | | 15.00 | 20.00 | 25.00 | 25.00 | 25.00 |
| Oppanol B10N | Liquid | | | | | | | |
| | polyisobutylene | | | | | | | |
| Indopol H6000 | Liquid | | | | | | | |
| | polybutene | | | | | | | |
| Regalite R 1100 | Hydrogenated | | 48.00 | 48.00 | 48.00 | 48.00 | 48.00 | 48.00 |
| | HC resin | | | | | | | |
| Irganox 1726 | Aging inhibitor | | 2.00 | 2.00 | 2.00 | 2.00 | 2.00 | 2.00 |
| | | | 100.0 | 100.0 | 100.0 | 100.0 | 100.0 | 100.0 |

| | | | | | | | |
|---|---|---|---|---|---|---|---|
| | PA PP fresh | 4.2 | 3.9 | 4.2 | 9.6 | 9.4 | 8.1 |
| | [N/cm] | | | | | | |
| | 300 mm/min | 5.2 | 6.3 | 5.4 | 7.6 | 8.7 | 7.7 |
| | [N/cm] | | | | | | |
| PA ASTM steel | 30 mm/min | 15.0 | 5.6 | 5.9 | 8.9 | 8.1 | 8.0 |
| | [N/cm] | | | | | | |
| | 3 mm/min | 2.9 | 6.7 | 8.2 | 2.1 | 1.6 | 3.0 |
| | [N/cm] | | | | | | |
| | MST max | 63 | 44 | 47 | 349 | 221 | 266 |
| | 1N [μm] | | | | | | |
| | MST min | 40 | 26 | 28 | 301 | 173 | 208 |
| | [μm] | | | | | | |

By “liquid” is meant that the starting materials are liquid at room temperature (softening point less than 60° C. or 40°0 C., respectively).

Indopol H6000: polyisobutene-polybutene copolymer

Regalite R 1100: hydrogenated hydrocarbon resin with a softening point of 100° C. from Eastman

Irganox 1726: phenolic antioxidant with sulfur-based function of a secondary antioxidant

| | | | Comp. | Comp. | Comp. | Comp. |
|---|---|---|---|---|---|---|
| Raw material | Type | Mooney viscosity | Ex. 1 | Ex. 2 | Ex. 3 | Ex. 4 |
| Vistalon 6602 | EPDM 49% ethylene | 25 (ML 1 + 4 125° C.) | | | | |
| Vistalon 2502 | EPDM 55% ethylene | 80 (ML 1 + 4 125° C.) | 25.50 | | 25.50 | |
| Keltan 69500 | EPDM 44% ethylene | 65 (ML 1 + 4 125° C.) | | 25.50 | | 25.50 |
| Vistalon 5601 | EPDM 69% ethylene | 72 (ML 1 + 4 125° C.) | 20.00 | | | |
| Royalene 563 | EPDM 57% ethylene | 75 (ML 1 + 4 125° C.) | | | | |
| Royalene 547 | EPDM 57% ethylene | 80 (ML 1 + 4 125° C.) | | | | |
| Ondina 933 | Liquid paraffinic | | | 20.00 | | |
| | white oil | | | | | |
| Trilene 67 | Liquid EPDM | | | | | |
| Oppanol B10N | Liquid polyisobutylene | | | | 20.00 | |
| Indopol H6000 | Liquid polybutene | | | | | 20.00 |
| Regalite R 1100 | Hydrogenated HC resin | | 52.50 | 52.50 | 52.50 | 52.50 |
| Irganox 1726 | Aging inhibitor | | 2.00 | 2.00 | 2.00 | 2.00 |
| | | | 100.0 | 100.0 | 100.0 | 100.0 |

| | | | | | |
|---|---|---|---|---|---|
| | PA PP fresh [N/cm] | 8.7 | 3.4 | 0.1 | 0.2 |
| | 300 mm/min [N/cm] | | | | |
| PA ASTM steel | 30 mm/min [N/cm] | | | | |
| | 3 mm/min [N/cm] | | | | |
| | MST max 1N [μm] | >2000 | 851 | 156 | 156 |
| | MST min [μm] | — | 790 | 109 | 109 |

Inventive examples 1 to 6, irrespective of the EPDM rubber used, show the very good properties of the compositions of the invention.

In particular, the PSAs, with peel adhesions of >3.0 N/cm, combine good bond strength on low-energy substrates (polypropylene) with a sufficient shear strength (micro-shear travel <500 μm).

Comparative examples 1 and 2 do display a very good peel adhesion, as a result of the addition of paraffinic plasticizers. For many applications, however, the shear strength is not sufficient. As described in the prior art, the plasticizers which can be used include polymeric plasticizers such as polyisobutylenes of polybutylenes. As a result of the polymeric character, these plasticizers do not weaken the shear strength. Comparative examples 3 and 4 therefore exhibit good micro-shear travel figures. In the case of these formulations, however, the peel adhesion on low-energy surfaces is too low. All in all, only the compositions of the invention exhibit both good peel adhesion and high shear strength.

1. A pressure-sensitive adhesive which comprises, as base polymer, at least one or more solid EPDM rubbers and tackifier resins, the fraction of the tackifier resins being 30 to 130 phr, wherein
the adhesive is plasticizer-free.

2. The pressure-sensitive adhesive as claimed in claim 1, wherein
the base polymer consists EPDM rubbers.

3. The pressure-sensitive adhesive as claimed in claim 1, wherein
the EPDM rubbers, besides ethylene and propylene, comprise diene ethylidene-norbornene (ENB), dicyclopentadiene or 5-vinyl-2-norbornene.

4. The pressure-sensitive adhesive as claimed in claim 1, wherein
the fraction of the tackifier resins is 50 to 120 phr.

5. The pressure-sensitive adhesive as claimed in claim 1, wherein
the Mooney viscosity (ML 1+4/125° C.) of the EPDM rubbers, measured according to DIN 53523, is at least 20 to 120.

6. The pressure-sensitive adhesive as claimed in claim 1, comprising
at least one liquid EPDM rubber.

7. The pressure-sensitive adhesive as claimed in claim 5, wherein
the fraction of the liquid EPDM rubbers is up to 40 wt %.

8. The pressure-sensitive adhesive as claimed in claim 1, consisting
of a composition only of solid, or only of solid and liquid, EPDM rubbers and tackifier resin, and optionally againg inhibitors.

9. The pressure-sensitive adhesive as claimed in claim 1, wherein
the fractions of all added substances besides EPDM rubbers and tackifier resin do not exceed a total of 5 wt %.

10. An adhesive tape selected from a single-sided adhesive tape and a double-sided adhesive tape, comprising the pressure-sensitive adhesive as claimed in claim 1.

11. The adhesive tape of claim 10, wherein the coat weight (coating thickness) of the pressure-sensitive adhesive is between 10 and 150 g/m².

12. The pressure-sensitive adhesive of claim 2, wherein the only polymer present is the EPDM rubbers.

13. The pressure-sensitive adhesive of claim 4, wherein the fraction of the tackifier resins is 60 to 110 phr.

14. The pressure-sensitive adhesive of claim 5, wherein the Mooney viscosity (ML 1+4/125° C.) of the EPDM rubbers, measured according to DIN 53523, is 40 to 90.

15. The pressure-sensitive adhesive of claim 7, wherein the fraction of the liquid EPDM rubbers is between 5 and 35 wt %.

16. The pressure-sensitive adhesive of claim 9, wherein the fractions of all added substances, besides EPDM rubbers and tackifier resin, do not exceed a total of 2 wt %.

17. The pressure-sensitive adhesive of claim 9, wherein the added substances include synthetic rubbers and/or thermoplastic elastomers and/or fillers and/or dyes and/or aging inhibitors.

18. The pressure-sensitive adhesive of claim 16, wherein the added substances include synthetic rubbers and/or thermoplastic elastomers and/or fillers and/or dyes and/or aging inhibitors.

19. The adhesive tape of claim 11, wherein the coat weight is between 15 and 100 g/m².
